(19) United States
(12) Patent Application Publication
(10) Pub. No.: US 2026/0177032 A1
(43) Pub. Date: Jun. 25, 2026

(54) GEARBOX UNIT AND WIND POWER GENERATION DEVICE

(71) Applicant: Envision Energy Co., Ltd., Jiangsu (CN)

(72) Inventors: Stephan UHKOTTER, Jiangsu (CN); Matthias WALKOWIAK, Jiangsu (CN); Ralf RUSCHOFF, Jiangsu (CN); Bo GAO, Jiangsu (CN); Kurt ANDERSEN, Jiangsu (CN)

(21) Appl. No.: 19/537,469

(22) Filed: Feb. 11, 2026

Related U.S. Application Data
(63) Continuation of application No. PCT/CN2024/086018, filed on Apr. 3, 2024.

(51) Int. Cl. F03D 9/11; F03D 9/25; G06F 1/30

(52) U.S. Cl. CPC F03D 9/11; F03D 9/25; F03D 9/255; G06F 1/30

(57) ABSTRACT

The disclosure is directed to a gearbox unit for a wind power generation device, comprising a gearbox; an lubricant supply system or cooling and/or lubricating the gearbox, the lubricant supply system comprising an electric pump discharging the lubricant; a primary power source; a backup power source; and a power controller configured to control a supply of the electrical power from the primary power source and the backup power source to the electric pump. Further, the disclosure is directed to a wind power generation device comprising a rotor; a main shaft; the gearbox unit; and a generator.

### CROSS-REFERENCE TO RELATED APPLICATION

This application is a continuation of PCT Patent Application No. PCT/CN2024/086018, entitled “GEARBOX UNIT AND WIND POWER GENERATION DEVICE”, filed on Apr. 3, 2024, which is incorporated by reference herein in its entirety.

### TECHNICAL FIELD

The disclosure is directed to a gearbox unit for a wind power generation device (also referred to as a turbine or a wind turbine). The gearbox unit comprises a gearbox and a lubricant supply system configured to supply lubricant to the gearbox for cooling and/or lubricating the gearbox. Further, the disclosure is directed to a wind power generation device comprising the gearbox unit.

### BACKGROUND

In general, the gearbox unit needs cooling and/or lubrication in order to function reliably and in order to avoid damage of the gearbox. For cooling and/or lubricating so-called mechanical pumps (also referred to as mechanically driven pumps) and so-called electric pumps (also referred to as electrically driven pumps) can be used. A mechanical pump is understood to mean a pump which can be driven by the gearbox, that is, by mechanical coupling with a rotation of a gear element of the gearbox. An electric pump is understood to mean a pump which can be electrically (motor-)driven. A pump effect as such (of the mechanical pump and/or the electric pump) may be achieved by the design of a positive-displacement pump, e.g. a gear pump.

An electric pump (or a respective motor for driving the pump) needs to be provided with electrical power. Usually, the electrical power is provided by a power source. The power source may be fed by an external grid (also referred to as a grid). When there is a grid failure, the power source also fails so that the electric pump can no longer be supplied with power. Hence, if the electric pump is the complete lubricant supply, sufficient cooling and/or lubrication cannot be ensured and the gearbox will be damaged. In particular, in case of a power cut of the (external) grid, the wind power generation device usually starts to shut down immediately in a controlled manner, but this can take two to three minutes. Especially during this shutdown period, damage to the gearbox can occur if an adequate supply of lubricating oil is not guaranteed.

For these cases, there are lubricant supply systems that have both an electric pump and a mechanical pump, so that in the event of a grid failure, the mechanical pump can maintain a certain lubricant supply due to its rotational coupling with the gearbox. A lubricant supply system comprising a mechanical pump as well as an electric pump is known from WO 2015/058900 A1. However, this redundant design of the two pump systems, in which the mechanical pump must be dimensioned so large that its pumping capacity alone ensures that a shutdown wind turbine is not damaged, is relatively expensive and complex in its design. In addition, for some power generation devices, for reasons of installation space, it is not possible to integrate a mechanical pump or it is only possible to integrate a small mechanical pump, which is not sufficient to ensure a safe shutdown.

### SUMMARY

It is therefore the object of the disclosure to avoid or at least reduce the disadvantages of the related art and to provide a gearbox unit as well as a wind power generation device with a gearbox unit in which sufficient lubrication can be guaranteed at preferably all times during operation, in particular during a power cut of an external grid. In addition, the gearbox unit and the wind power generation device should be cost-effective and efficient.

This object is solved by a gearbox unit and by a wind power generation device with the features of the independent claims. Further advantageous developments of the present disclosure are made to the subject-matter of the respective sub claims and/or are discussed herein below.

The disclosure is directed to a gearbox unit for a wind power generation device. The gearbox unit comprises a gearbox comprising an input element and an output element. The input element is configured to be rotationally coupled with a main shaft of the wind power generation device. The output element is rotationally coupled to the input element such that a rotational speed is increased from the input element to the output element. The gearbox unit comprises a lubricant supply system configured to supply lubricant to the gearbox for cooling and/or lubricating the gearbox. The lubricant supply system comprises an electric pump discharging the lubricant. The gearbox unit comprises a primary power source configured to supply electrical power to the electric pump. The gearbox unit comprises a backup power source configured to supply electrical power to the electric pump. The gearbox unit comprises a power controller configured to control a supply of the electrical power from the primary power source and the backup power source to the electric pump. In the gearbox unit, the power controller is configured to control the supply of the electrical power such that the electric pump is supplied by the backup power source in case an available electrical power of the primary power source is less than a required electrical power of the electric pump, in particular in case of a failure of the primary power source due to a power cut of an external grid.

In other words, in the event of insufficient supply to the electric pump from the primary power source, in particular in the event of a power failure, a lubricant supply is ensured by the backup power source. In particular, this ensures a safe shutdown during a grid failure.

According to a preferred embodiment, the gearbox unit, in particular the gearbox, may further comprise a main shaft bearing configured to rotatably support the main shaft of the wind power generation device. The lubricant supply system may be configured to supply lubricant to the main shaft bearing. Thus, lubricant supply of the main shaft bearing can be ensured.

According to a preferred embodiment, the backup power source may be an uninterruptible power supply. The uninterruptible power supply/source may be a type of continual power system that provides automated backup electrical power to a load when the input power source or main power fails. A UPS may differ from a traditional auxiliary/emergency power system or standby generator in that it will provide near-instantaneous protection from input power interruptions by switching to energy stored in battery packs, supercapacitors or flywheels.

According to a preferred embodiment, the backup power source may be a battery and/or a supercapacitor. Thus, near-instantaneous protection may be provided.

According to a preferred embodiment, the backup power source may be configured to supply a power amount of electrical power to the electric pump. The power amount may be sufficient for the electric pump to discharge a volume flow of at least 25%, preferably 50%, in particular 75%, of a maximum volume flow of the electric pump. The power amount may be sufficient for the electric pump to discharge a volume flow of at least 650 L/min, preferably 750 L/min, in particular 850 L/min. The maximum flow of the electric pump is a total oil flow. That is, the electric pump may be an electric pump device comprising more than one pump (e.g. two or three pumps) and the maximum flow is the flow of all of the pumps of the electric pump device.

According to the preferred embodiment, the backup power source may have a power capacity of at least 20 kW, preferably 26 kW. Thus, enough power is provided to shut down safely.

According to a preferred embodiment, the backup power source may be configured to supply an energy amount of electrical power to the electric pump. The energy amount may be sufficient for the electric pump to discharge the volume flow for at least 1 minute, preferably at least 2 minutes, in particular at least 3 minutes.

According to the preferred embodiment, the backup power source may have an energy capacity of at least 15 kWh, preferably at least 20 kWh. Thus, enough energy is provided to shut down safely.

According to a preferred embodiment, the backup power source may be rechargeable. That is, the backup power source does not have to be replaced after a single use, but can be used repeatedly for a long period of time.

According to a preferred embodiment, the backup power source may be an online power source. That is, the backup power source may be permanently connected to the electric pump. Thus, it is not necessary to switch to the backup power source when required.

According to an alternative preferred embodiment, the backup power source may be an on demand power source. That is, the backup power source may be connectable to the electric pump (and disconnectable from the electric pump). In particular, the backup power source may be connectable or connected to the electric pump as required.

According to a preferred embodiment, the electric pump may be an electric pump device comprising a primary electric pump motor and a backup electric pump motor. The primary power source may be configured to supply electrical power to the primary electric pump motor. The backup power source may be configured to supply electrical power to the backup electric pump motor. That is, there may be two independent electric pump motors and respective power sources. Alternatively, there may be two independent power sources supplying the same electric pump motor with electrical power.

According to a preferred embodiment, the power controller may be configured to control the backup power source in a backup operating mode in such a way that a constant volume flow discharged by the electric pump is maintained. Thus, a sufficient cooling and/or lubricating can be ensured. In addition, a control of the backup operating mode can be kept simple.

According to an alternative preferred embodiment, the power controller may be configured to control the backup power source in a backup operating mode in such a way that a volume flow discharged by the electric pump is gradually reduced, preferably in accordance with the rotational speed of the main shaft. That is, the volume flow discharged by the electric pump may be adapted to a demanded volume flow, the demanded volume flow decreasing with decreasing rotational speed. Thus, an efficient supply of the electrical power is ensured. This has the advantage that the cooling and/or lubricating can be maintained for as long as possible.

According to a preferred embodiment, the power controller may be configured to check a functionality, in particular a battery status, of the backup power source, in particular when starting up the wind power generation device. Thus, a safe shutdown is ensured at all times and the occurrence of an undesired, potentially damaging state is prevented at any time.

According to a preferred embodiment, the power controller may be configured to recognize a power cut of an external grid. Thus, it is possible to react quickly.

According to a preferred embodiment, the power controller may comprise a primary controller and a backup controller redundantly controlling the electric pump, in particular the supply of the electrical power from the primary power source and/or the backup power source to the electric pump. Thus, a potential damage due to malfunction or failure of the controller can be avoided through redundancy.

According to a preferred embodiment, the power controller may comprise a watchdog between the primary controller and the backup controller. Thus, a failure detection function can be provided.

According to a preferred embodiment, the gearbox unit may further comprise a controller backup power source configured to supply electrical power to the primary controller, in particular in case of a failure of the primary power source due to a power cut of an external grid. Thus, the power supply to the power controller is ensured at preferably all times during operation, in particular, independent of the power supply of the electric pump.

According to a preferred embodiment, the lubricant supply system may comprise a mechanical pump discharging the lubricant. The mechanical pump may be rotationally coupled with the gearbox to drive the mechanical pump. Thus, a power-independent lubricant supply can be provided in addition to the electric pump (electrically (driven) pump). This has the advantage that it is possible to reduce the amount of oil (of the electric pump) or the emergency power supply of the backup power source.

Further, the disclosure is directed to a wind power generation device. The wind power generation device comprises a rotor comprising a plurality of blades and a hub. The rotor is configured to convert wind power into rotational energy of the hub when wind blows against the plurality of blades. The wind power generation device comprises a main shaft rotationally coupled with the hub. The wind power generation device comprises the gearbox unit (as described above). The input element of the gearbox is rotationally coupled with the main shaft. The wind power generation device comprises a generator rotationally coupled to the output element of the gearbox. The generator is configured to convert the rotational energy of the hub, being transmitted through the gearbox, into electric power.

According to a preferred embodiment, the gearbox may be an integrated gearbox, in particular the output element, being coaxially arranged to the generator. That is, the output element is preferably not rotationally coupled via a spur gear to the gearbox. In this case, it has advantages in terms of installation space not to provide a mechanical pump for emergency lubricant supply.

According to a preferred embodiment, the power controller may be configured to activate the watchdog and to initiate a shut down of the wind power generation device in case of a failure of the primary controller. By quickly recognising the failure of the primary controller, it is possible to react quickly and avoid undesirable situations.

According to a preferred embodiment, the power controller may be configured to activate the watchdog and to initiate a shutdown of the wind power generation device in case of a failure of the backup controller. By quickly recognising the failure of the backup controller, it is possible to react quickly and avoid undesirable situations.

According to a preferred embodiment, the plurality of blades may have an adjustable pitch angle and the backup power source may be configured to supply electrical power for adjusting the pitch angle. Thus, due to the emergency power supply, the blades can still be adjusted to a shut-down position even in the event of a grid failure.

According to a preferred embodiment, the wind power generation device may further comprise a tower supporting the rotor and having an adjustable rotation angle. The backup power source may be configured to supply electrical power for adjusting the rotation angle. Thus, due to the emergency power supply, the tower can still be adjusted to a shut-down position even in the event of a grid failure.

In other words, the disclosure deals with the problem that a partially or fully electrical lubricant pump system for wind turbine gearboxes is suffering an oil flow reduction or even oil flow cut in case of an electrical power cut. The disclosure addresses this problem by a backup power supply system for the electric pump system. This backup power supply comprises at least one power source, such as a battery and/or supercapacitor, and a power controller. This power controller controls the primary power supply for the electric pump system and compares the required power with the available power. If the available primary power does not fulfill the required power, the controller provides power from the backup power source. This status is kept until the primary power provides sufficient power again or the backup power source is completely consumed. The status of the backup power source may be checked on a regular basis to ensure the availability of the power source.

### BRIEF DESCRIPTION OF THE DRAWINGS

The disclosure is explained in more detail below on the basis of a preferred embodiment using figures. The figures are of a schematic nature and intended to improve the understanding of the disclosure. Same elements are referenced to with the same reference signs.

FIG. 1 shows a schematic illustration of a wind power generation device according to the present disclosure;

FIG. 2 shows a schematic illustration of a gearbox unit according to the present disclosure;

FIG. 3 shows a functional illustration of a control of the gearbox unit;

FIG. 4 shows an operating principle of a first embodiment of the disclosure; and

FIG. 5 shows an operating principle of a second embodiment of the disclosure.

### DETAILED DESCRIPTION OF THE EMBODIMENTS

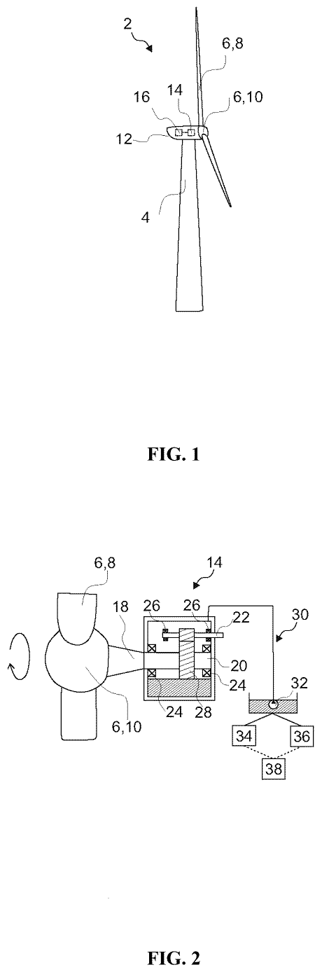

FIG. 1 shows a schematic illustration of a wind power generation device 2 according to the present disclosure. The wind power generation device 2 may comprise a tower 4. The tower 4 may have an adjustable rotation angle. The rotation angle may be adjustable around a longitudinal axis of the tower 4 for orientating the tower 4 in dependence of a wind direction.

The wind power generation device 2 may comprise a rotor 6. The rotor 6 may comprise a plurality of blades 8 and a hub 10. The rotor 6 may be configured to convert wind power into rotational energy of the hub 10 when wind blows against the plurality of blades 8. The rotor 6 may be supported by the tower 4, in particular at the top of the tower 4. The plurality of blades 8 may have an adjustable pitch angle. The pitch angle may be adjustable around a longitudinal axis of each of the blades 8 for orientating the blades 8 in dependence of a wind direction.

The wind power generation device 2 may comprise a nacelle 12. The nacelle 12 may be supported by the tower 4, in particular at the top of the tower 4.

The wind power generation device 2 may comprise a gearbox 14. The gearbox 14 may (be configured to) be rotationally coupled with the rotor 6. In particular, the gearbox 14 may be configured to increase a rotational speed. The gearbox 14 may be housed in the nacelle 12.

The wind power generation device 2 may comprise a generator 16. The generator 16 may (be configured to) be rotationally coupled with the gearbox 14. The generator 16 may be configured to convert rotational energy into electric power. In particular, the generator 16 may be configured to convert the rotational energy of the hub 10 being transmitted through the gearbox 14. In particular, the gearbox 14 may be provided to increase a rotational speed from the rotor 6 to the generator 16. The generator 16 may be housed in the nacelle 12.

The wind power generation device 2 may comprise a main shaft 18 rotationally coupled with the hub 10 and the gearbox 14 (see FIG. 2).

FIG. 2 shows a schematic illustration of a part of the wind power generation device 2. In particular, FIG. 2 shows a schematic illustration of a gearbox unit according to the present disclosure.

The gearbox unit may comprise the gearbox 14. The gearbox 14 may comprise an input element 20 (also referred to as an input shaft) and an output element 22 (also referred to as an output shaft). The input element 20 may (be configured to) be rotationally coupled with the main shaft 18 of the wind power generation device 2. The input element 20 may be formed in one piece with the main shaft 18 as a single continuous shaft. The output element 22 may (be configured to) be rotationally coupled with the generator 16 of the wind power generation device 2.

The gearbox 14 may comprise a first bearing (arrangement) 24, in particular two bearings, for rotatably supporting the input element 20. The gearbox 14 may comprise a second bearing (arrangement) 26, in particular two bearings, for rotatably supporting the output element 26.

The gearbox unit may comprise a main shaft bearing (arrangement) for rotatably supporting the main shaft 18 of the wind power generation device 2. The first bearing 24 may form the main shaft bearing. Thus, the first bearing 24 may also be referred to as a main shaft bearing.

The input element 20 and the output element 22 may be rotationally coupled to each other such that a rotational speed is increased from the input element 20 to the output element 22. In particular, the gearbox 14 may have a gear stage 28 (also referred to as a transmission stage) rotationally coupling the input element 20 and the output element 22. In the illustrated embodiment, there is only a single gear stage shown, but there may also be several gear stages.

The gearbox unit may comprise a lubricant supply system 30. The lubricant supply system 30 may be configured to supply lubricant to the gearbox 14 for cooling and/or lubricating the gearbox 14. The lubricant may contain water and/or oil or the like. The lubricant supply system 30 may comprise an electric pump 32 discharging the lubricant. Thus, the lubricant is supplied to the gearbox 14 by driving the electric pump 32.

The gearbox unit may comprise a primary power source 34 (also referred to as a first power supply) configured to supply electrical power to the electric pump 32. In particular, the primary power source 34 is configured to be supplied with electrical power by an external grid.

The gearbox unit may comprise a backup power source 36 (also referred to as a second power supply) configured to supply electrical power to the electric pump 32.

The gearbox unit may comprise a power controller 38. The power controller 38 may be configured to control a supply of the electrical power from the primary power source 34 to the electric pump 32. The power controller 38 may be configured to control a supply of the electrical power from the backup power source 36 to the electric pump 32.

According to the present disclosure, the power controller 38 is configured to control the supply of the electrical power such that the electric pump 32 is supplied by the backup power source 36 in case an available electrical power of the primary power source 34 is less than a required electrical power of the electric pump 32.

In particular, the power controller 38 is configured to control the supply of the electrical power such that the electric pump 32 is supplied by the backup power source 36 in case of a failure of the primary power source 34 due to a power cut of the external grid.

Preferably, the backup power source 36 may be an uninterruptible power supply (also referred to as an uninterruptible power source). For example, the backup power source 36 may be a battery and/or a supercapacitor.

Preferably, the backup power source 36 may be configured to supply a power amount of electrical power to the electric pump 32. The power amount may be sufficient for the electric pump 32 to discharge a volume flow of at least 25%, preferably 50%, in particular 75%, of a maximum volume flow of the electric pump 32. The power amount may be sufficient for the electric pump 32 to discharge a volume flow of at least 650 L/min, preferably 750 L/min, in particular 850 L/min. Preferably, the backup power source 36 may have a power capacity of at least 20 kW, preferably 26 kW.

Preferably, the backup power source 36 may be configured to supply an energy amount of electrical power to the electric pump 32. The energy amount may be sufficient for the electric pump 32 to discharge the volume flow for at least 1 minute, preferably at least 2 minutes, in particular at least 3 minutes. Preferably, the backup power source 36 may have an energy capacity of at least 15 kWh, preferably at least 20 kWh.

Preferably, the backup power source 36 may be rechargeable.

Preferably, the backup power source 36 may be an online power source, that is, the backup power source 36 may be permanently connected to the electric pump 32. Alternatively, the backup power source 36 may be an on demand power source, that is, the backup power source 36 may be connectable (and disconnectable) to the electric pump 32, in particular as required.

Preferably, the gearbox unit may comprise a second backup power source. The second backup power source may be configured to supply electrical power to the primary controller 38. The second backup power source may also be referred to as a controller backup power source.

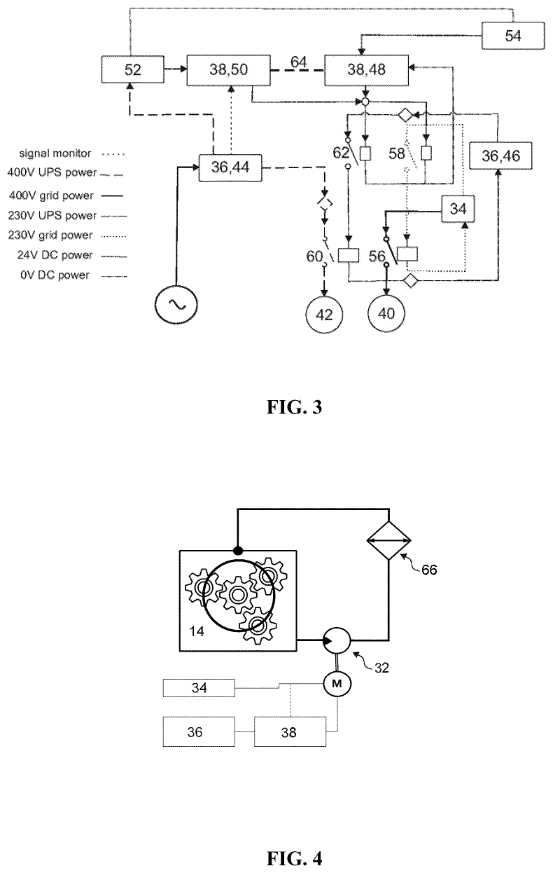

FIG. 3 shows a functional illustration of a control of the gearbox unit.

The electric pump 32 may be an electric pump device comprising two electric pumps or pump motors 40, 42, that is, a primary/first electric pump or pump motor 40 and a backup/second electric pump or pump motor 42. The primary power source 34 may be configured to supply electrical power to the primary electric pump or pump motor 40. The backup power source 36 may be configured to supply electrical power to the backup electric pump or pump motor 42.

The primary power source 34 may also be referred to as a (internal or external) grid. The backup power source 36 may also referred to as a gearbox UPS 44. The controller backup power source may also refer to a wind turbine generator UPS 46.

The power controller 38 may comprise a primary controller 48 and a backup controller 50. The primary controller may also be referred to as a main controller. The primary controller and the backup controller may redundantly control the electric pump 32, in particular the supply of the electrical power from the primary power source 34 and/or the backup power source 36 to the electric pump (the pump motors 40, 42). The backup controller 50 may be connected to the backup power source 36/gearbox UPS 44 via a signal monitor line.

The gearbox unit may comprise a backup power unit 52, which is e.g. a backup 24 V power unit. The gearbox unit may comprise a wind turbine generator power unit 54, which is e.g. a wind turbine generator 24V power unit.

The primary power source 34 may provide 400V grid power and/or 230V grid power. The gearbox UPS 44 may provide 400V UPS power. The wind turbine generator UPS 46 may provide 230V UPS power. The backup power unit 52 may provide 24V DC power. The wind turbine generator power unit 54 may provide 24V DC power.

The first pump motor 40 may be provided with 400V grid power (by the primary power source 34/grid). The second pump motor 42 may be provided with 400V UPS power (by the backup power source 36/the gearbox UPS 44).

The backup power source 36 (gearbox UPS 44) may be provided with 400V grid power.

The backup power unit 52 may be provided with 400V UPS power (by the backup power source 36/the gearbox UPS 44). The wind turbine generator power unit 54 may be provided with 230V UPS power (by the controller backup power source/wind turbine generator UPS 46). The backup power unit 52 and the wind turbine generator power unit 54 may be connected via a 0V DC power line.

The power controller 38 (in particular, the backup controller 50) may be provided with 24V DC power (by the backup power unit 52). The power controller 38 (in particular, the primary/main controller 48) may be provided with 24V DC power (by the wind turbine generator power unit 54).

The first pump motor 40 may be connected to the primary power source 34 (grid) via a first contactor/switch 56. The first contactor/switch 56 may be provided with 230V grid power (by the primary power source 34/grid). The first contactor/switch 56 may be connected to the primary power source 34 (grid) via a first relay 58. The first relay 58 may be provided with 24V DC power by the power controller 38 (the main controller 48 and/or the backup controller 50).

The second pump motor 42 may be connected to the backup power source 36 (gearbox UPS 44) via a second contactor/switch 60. The second contactor/switch 60 may be provided with 230V UPS power (by the controller backup power source/wind turbine generator UPS 46). The second contactor/switch 58 may be connected to the controller backup power source/wind turbine generator UPS 46 via a second relay 62. The second relay 62 may be provided with 24V DC power by the power controller 38 (the main controller 48 and/or the backup controller 50).

Further, the power controller 38 may comprise a watchdog 64 between the main controller 48 and the backup controller 50.

According to a first scenario, there is a grid power off, that is, primary power source 34 power off. The backup power source 36, in particular the gearbox UPS 44, will switch to battery power supply mode to provide power to the second (lubricant) pump motor 42. The backup power source 36, in particular the wind turbine generator UPS 46, will switch to battery power supply mode to provide power to the power controller 38, in particular the main controller 48, and the second contactor 60. The power controller 38, in particular the main controller 48, will keep the second relay 62 in closed state. The turbine (wind power generation device) will stop to idling mode within 1 minute. The result is that the gearbox second (lubricant) pump motor 42 remains running and provides enough lubricating lubricant after a power outage from the grid (primary power source 34).

According to a second scenario, there is a main controller 48 failure/crash. The watchdog 64 between the main controller 48 and the (redundant) backup controller 50 is activated. The backup controller 50 will keep the first relay 58 and the second relay 62 in closed state. The turbine (wind power generation device) will stop to idling mode within 1 minute. The result is that the gearbox second (lubricant) pump motor 42 and the first (lubricant) pump motor 40 remains running and provide enough lubricating lubricant after the main controller 48 crash.

According to a third scenario, there is a wind turbine generator power unit 54 failure/crash. The main controller 48 will shut down immediately. The watchdog 64 between the main controller 48 and the (redundant) backup controller 50 is activated. The backup controller 50 will keep the first relay 58 and the second relay 62 in closed state. The turbine (wind power generation device) will stop to idling mode within 1 minute. The result is that the gearbox second (lubricant) pump motor 42 and the first (lubricant) pump motor 40 remain running and provide enough lubricating lubricant after wind turbine generator power unit 54 failure.

According to a fourth scenario, there is a wind turbine generator UPS 46 failure/crash. The wind turbine generator power unit 54 powered by the generator UPS 46 will power down immediately. The main controller 48 will shut down immediately. The watchdog 64 between the main controller 48 and the (redundant) backup controller 50 is activated. The backup controller 50 will keep the first relay 58 and the second relay 62 in closed state. The first contactor 56 will remain closed because it is powered by the primary power source 34 (grid). The turbine (wind power generation device) will stop to idling mode within 1 minute. The result is that the first (lubricant) pump motor 40 remains running and provides enough lubricating lubricant after wind turbine generator UPS 46 failure.

According to a fifth scenario, the gearbox UPS 44 feeds back its power status to the backup controller 50 (signal monitor line) and the backup controller 50 passes the information to the main controller 48. If the main controller 48 receives a low battery signal of the UPS 44, the main controller 48 will not start the turbine (wind power generation device). Thus, it can be ensured that the gearbox UPS 44 can keep the second (lubricant) pump motor 42 running for at least 1 minute in the event of a grid power off. In order to ensure that the Gearbox UPS can keep the lubricant pump motor running for at least 1 minute in the event of primary power source 34 power off (a grid power off).

According to a sixth scenario, the watchdog 64 between the main controller 48 and the backup controller 50 is bidirectional. When the backup controller 50 is abnormal, the watchdog 64 will be activated, and the main controller 48 will stop to idling mode within 1 minute and inform the user that there is an abnormality in the backup controller 50.

FIG. 4 shows an operating principle of a first embodiment of the disclosure. The gearbox 14 is supplied with lubricant (oil) by the electric pump 32 (or the electric pump device with one, two, three or more pumps). The lubricant (oil) may be transferred to the gearbox via a heat exchanger 66. The electrical power is supplied to a motor of the electric pump 32 by the primary power source 34 or the backup power source 36. The power controller 38 controls the power supply to the electric pump 32.

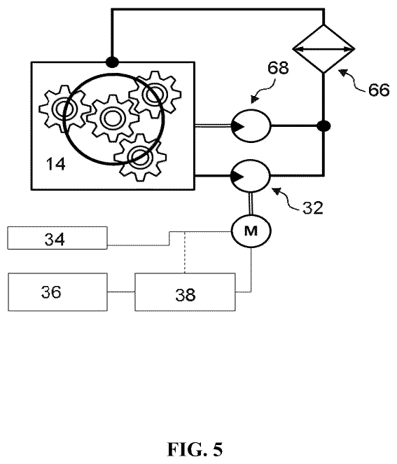

FIG. 5 shows an operating principle of a second embodiment of the disclosure. The gearbox 14 is supplied with lubricant (oil) by the electric pump 32 (or the electric pump device with one, two, three or more pumps) and by a mechanical pump 68. The lubricant (oil) may be transferred to the gearbox via the heat exchanger 66. The electrical power is supplied to a motor of the electric pump 32 by the primary power source 34 or the backup power source 36. The power controller 38 controls the power supply to the electric pump 32.

What is claimed is:

1. A gearbox unit for a wind power generation device, comprising
a gearbox comprising an input element configured to be rotationally coupled with a main shaft of the wind power generation device and an output element rotationally coupled to the input element, wherein a rotational speed is increased from the input element to the output element;
a lubricant supply system configured to supply lubricant to the gearbox for cooling and/or lubricating the gearbox, the lubricant supply system comprising an electric pump operable to discharge the lubricant;
a primary power source;
a backup power source; and
a power controller configured to control supply of electrical power from the primary power source and/or the backup power source to the electric pump, whereby the electrical power is supplied from the backup power source in response to an available electrical power from the primary power source falling below a predetermined threshold that is less than a required electrical power of the electric pump.

2. The gearbox unit according to claim 1, further comprising
a main shaft bearing configured to rotatably support the main shaft of the wind power generation device, wherein the lubricant supply system is configured to supply lubricant to the main shaft bearing.

3. The gearbox unit according to claim 2, wherein the backup power source is configured to supply a power amount of electrical power to the electric pump, the power amount being sufficient for the electric pump to discharge a volume flow of at least 25%, of a maximum volume flow of the electric pump or a volume flow of at least 650 L/min.

4. The gearbox unit according to claim 3, wherein the backup power source has a power capacity of at least 20 kW.

5. The gearbox unit according to claim 4, wherein the backup power source is configured to supply an energy amount of electrical power to the electric pump, the energy amount being sufficient for the electric pump to discharge the volume flow for at least 1 minute.

6. The gearbox unit according to claim 5, wherein the backup power source has an energy capacity of at least 15 kWh.

7. The gearbox unit according to claim 6, wherein the electric pump is an electric pump device comprising a primary electric pump motor and a backup electric pump motor, wherein the primary power source is configured to supply electrical power to the primary electric pump motor and the backup power source is configured to supply electrical power to the backup electric pump motor.

8. The gearbox unit according to claim 7, wherein the power controller is configured to control the backup power source in a backup operating mode in such a way that a constant volume flow discharged by the electric pump is maintained.

9. The gearbox unit according to claim 8, wherein the power controller is configured to control the backup power source in a backup operating mode in such a way that a volume flow discharged by the electric pump is gradually reduced, in accordance with the rotational speed of the main shaft.

10. The gearbox unit according to claim 9, wherein the power controller is configured to check a functionality, in particular a battery status, of the backup power source, in particular when starting up the wind power generation device.

11. The gearbox unit according to claim 10, wherein the power controller is configured to recognize a power cut of an external grid.

12. The gearbox unit according to claim 11, wherein the power controller comprises a primary controller and a backup controller redundantly controlling the electric pump, including the supply of electrical power from at least one of the primary power source and the backup power source to the electric pump.

13. The gearbox unit according to claim 12, wherein the power controller comprises a watchdog between the primary controller and the backup controller.

14. The gearbox unit according to claim 13, further comprising
a controller backup power source configured to supply electrical power to the primary controller, in particular in case of a failure of the primary power source due to a power cut of an external grid.

15. The gearbox unit according to claim 14, wherein the lubricant supply system comprises a mechanical pump discharging the lubricant, the mechanical pump being rotationally coupled with the gearbox to drive the mechanical pump.

16. A wind power generation device, comprising
a rotor comprising a plurality of blades and a hub, the rotor being configured to convert wind power into rotational energy of the hub when wind blows against the plurality of blades;
a main shaft rotationally coupled with the hub;
a gearbox unit according to claim 1, the input element being rotationally coupled with the main shaft; and
a generator rotationally coupled to the output element of the gearbox, the generator being configured to convert the rotational energy of the hub, being transmitted through the gearbox, into electric power.

17. The wind power generation device according to claim 16, wherein the gearbox is an integrated gearbox, in particular the output element, being coaxially arranged to the generator.

18. The wind power generation device according to claim 17, wherein the power controller comprises a watchdog between the primary controller and the backup controller, and is configured to activate the watchdog and to initiate a shutdown of the wind power generation device in case of a failure of at least one of the primary controller and the backup controller.

19. The wind power generation device according to claim 18, wherein the plurality of blades has an adjustable pitch angle and the backup power source is configured to supply electrical power for adjusting the pitch angle.

20. The wind power generation device according to claim 19, further comprising
a tower supporting the rotor and having an adjustable rotation angle, wherein the backup power source is configured to supply electrical power for adjusting the rotation angle.
